(19) United States
(12) Patent Application Publication
(10) Pub. No.: US 2011/0118636 A1
(43) Pub. Date: May 19, 2011

(54) MASSAGE MACHINE AND MASSAGE METHOD

(75) Inventors: Akira Kitamura, Tottori (JP); Daisuke Kushida, Tottori (JP); Hideshi Kondo, Osaka (JP); Masashi Fujikawa, Osaka (JP)

(73) Assignee: Tottori University, Tottori-shi (JP)

(21) Appl. No.: 12/863,095

(22) PCT Filed: Feb. 3, 2009
(86) PCT No.: PCT/JP2009/051764

§ 371 Date: Jul. 15, 2010

(30) Foreign Application Priority Data
Feb. 12, 2008 (JP) 2008-030342

(51) Int. Cl. A61H 7/00

(52) U.S. Cl. 601/84

(57) ABSTRACT

There are equipped: a massage unit (5) for applying a massage operation to the user; a brain wave acquisition section (18) for acquiring the brain wave of the user being massaged by the massage unit (5); an operation control section (17) for controlling the massage operation by the massage unit (5) based on the brain wave acquired by the brain wave acquisition section (18); and an electromagnetic noise elimination section (19) for eliminating an electromagnetic noise. In accordance with the massage operation during the acquisition of the brain wave, the electromagnetic noise elimination section (19) eliminates the electromagnetic noise caused by the massage unit (5) performing the massage operation from the brain wave acquired by the brain wave acquisition section (18).

### TECHNICAL FIELD

The present invention relates to a massage machine and a massage method.

### BACKGROUND ART

Conventionally, a chair-type massage machine having a massage unit inside the backrest section thereof is available. This massage unit has a treatment device formed of massaging balls, and this treatment device is driven through a motor or the like, whereby the treatment device performs massage operations, such as rubbing, pounding and finger pressure.

In such massage machine, the massage operations can be changed when the user operates a controller; however, the massage output thereof, such as the finger pressure intensity, is set to a constant value. For this reason, even if the user feels painful, the massage machine always continues to perform massage at the output. In other words, the user's comfortableness degree is not considered for the massage output.

To solve this problem, as disclosed in JP-2007-215671-A, there is proposed a massage machine in which the operation of the massage unit thereof is controlled based on the brain wave acquired from the user so as to be able to adjust the massage output thereof.

### DISCLOSURE OF THE INVENTION

The above-mentioned massage machine acquires the user's brain wave as an indicator for judging the comfortableness degree during massage and uses this to control the operation of the massage unit. In other words, the operation output of the massage unit is adjusted based on the acquired brain wave to enhance the comfortableness degree during massage.

However, when the brain wave is acquired while the massage machine is actually used, various kinds of noise (artifact) are included in the brain wave while the brain wave is acquired. If the operation of the massage unit is controlled based on the brain wave including the effect of noise, improper output may be applied to the user.

Accordingly, an object of the present invention is to provide a massage machine and a massage method capable of appropriately setting the output of the massage operation to be applied to the user.

To achieve the above-mentioned object, the present invention provides a massage machine including a massage machine main body that massages the user; a brain wave acquisition section that acquires a brain wave of the user being massaged by the massage machine main body; and an operation control section that controls an operation of the massage machine main body based on the brain wave acquired through the brain wave acquisition section, the massage machine further including a massage noise elimination section that eliminates a noise caused by the operation of the massage machine main body from the brain wave acquired through the brain wave acquisition section, based on the operation of the massage machine main body during an acquisition of the brain wave.

While the massage machine main body operates to massage the user, noise caused by the massage machine main body may be included in the brain wave acquired through the brain wave acquisition section. However, the massage noise elimination section eliminates the noise caused by the operation of the massage machine main body from the acquired brain wave during the acquisition of the brain wave, whereby noise in the thus-obtained brain wave can be suppressed. As a result, the massage output to be applied from the massage machine main body to the user can be made appropriate by controlling the massage operation using the operation control section based on the brain wave.

In addition, it is preferable that the massage noise elimination section has a storage section that stores related information regarding the relationship between the operation of the massage machine main body and a noise component caused by the massage machine main body performing the operation; and a processing section that obtains the noise component corresponding to the operation of the massage machine main body during the acquisition of the brain wave from the related information and that eliminates the thus-obtained noise component from the brain wave acquired through the brain wave acquisition section.

With this configuration, the processing section can eliminate the noise caused by the massage machine main body from the brain wave based on the operation of the massage machine main body. Furthermore, since the noise component corresponding to the operation of the massage machine main body during the acquisition of the brain wave can be obtained from the related information stored in the storage section, the process of eliminating the noise from the brain wave can be performed promptly. The noise component caused by the massage machine main body are the frequency component of the noise caused by the massage machine main body, for example.

Moreover, it is preferable that the massage machine further includes an action noise elimination section that eliminates an action noise caused by an user's action from the brain wave acquired through the brain wave acquisition section.

With this massage machine, noise caused by the action of the user whose brain wave is being acquired can be eliminated. Although it is known that the eyeball action (for example, blinking) of the user affects the measurement of the brain wave, the effect to the brain to be acquired can be suppressed in this massage machine even when the user blinks, for example.

Besides, it is preferable that the action noise elimination section has a judgment section that judges a presence of the action noise; and a selection section that excludes a portion including the action noise from the brain wave as an operation control subject for the massage machine main body by the operation control section, based on a judgment result of the judgment section.

With the action noise elimination section, the portion including the action noise is eliminated from the brain wave as the operation control subject for the massage machine main body by the operation control section; hence, a brain wave in which the action noise is suppressed can be obtained.

Further, the judgment section of the action noise elimination section can judge the presence of the action noise by comparing an output value of the brain wave acquired through the brain wave acquisition section with preset threshold value.

With this configuration, when the user performs an action, for example, blinking, the output value of the brain wave increases; hence, with the judgment section, the presence of the action noise can be judged by comparing the output value of the brain wave acquired through the brain wave acquisition section with the preset threshold value.

Still further, the judgment section of the action noise elimination section can judge the presence of the action noise by comparing a waveform of the brain wave acquired through the brain wave acquisition section with a model waveform of the action noise caused by the user's action.

With this configuration, when the user performs an action, for example, blinking, the brain wave has a specific waveform; hence, with the judgment section, the presence of the action noise can be judged by comparing the waveform of the brain wave acquired through the brain wave acquisition section with the model waveform of the action noise.

Additionally, it is preferable that the action noise elimination section further has a trend elimination section that performs a moving average process on the brain wave acquired through the brain wave acquisition section and that subtracts the brain wave subjected to the moving average process from the brain wave acquired through the brain wave acquisition section.

When the user performs an action slowly (for example, when an eyeball action is performed), the brain wave fluctuates gently; however, with this configuration, the fluctuation in the brain wave can be eliminated.

Furthermore, it is preferable that a display section is provided to display, to the user, an user's brain wave state obtained based on the brain wave having been subjected to the noise elimination processes.

With this configuration, the user being massaged can see the display section and can know his or her brain wave state (for example, whether the user feels comfortable or uncomfortable).

Moreover, a massage method capable of being performed by the massage machine acquires the brain wave of the user being massaged by the massage machine, eliminates noise caused by the massage machine from the acquired brain wave, and controls the massage operation performed by the massage machine based on the brain wave from which the noise is eliminated.

### BRIEF DESCRIPTION OF THE DRAWINGS

FIG. 1 is an explanatory view showing an embodiment of a massage machine according to the present invention.

FIG. 2 is a front perspective view showing a massage unit.

FIG. 3 is a block diagram showing the main part of the massage machine according to the present invention.

FIGS. 4A and 4B are views showing a brain wave including action noise caused by blinking, FIG. 4A showing the brain wave in a time domain, FIG. 4B showing the brain wave in a frequency domain.

FIGS. 5A to 5C are explanatory views explaining the function of a correlation coefficient judgment section.

FIGS. 6A and 6B are views showing a brain wave excluding action noise, FIG. 6A showing the brain wave in a time domain, FIG. 6B showing the brain wave in a frequency domain.

FIGS. 7A and 7B are views showing a brain wave during pounding massage, FIG. 7A showing the brain wave in a frequency domain, FIG. 7B showing a magnified view of 18 to 21 Hz zone.

FIGS. 8A and 8B are views showing a brain wave during rubbing massage, FIG. 8A showing the brain wave in a frequency domain, FIG. 8B showing a magnified view of 18 to 21 Hz zone.

FIG. 9 is an explanatory view showing related information stored in a storage section.

FIGS. 10A to 10E are explanatory views showing examples of brain wave states displayed on the monitor.

### BEST MODES FOR CARRYING OUT THE INVENTION

An embodiment according to the present invention will be described below based on the drawings.

### [Overall Configuration of Massage Machine]

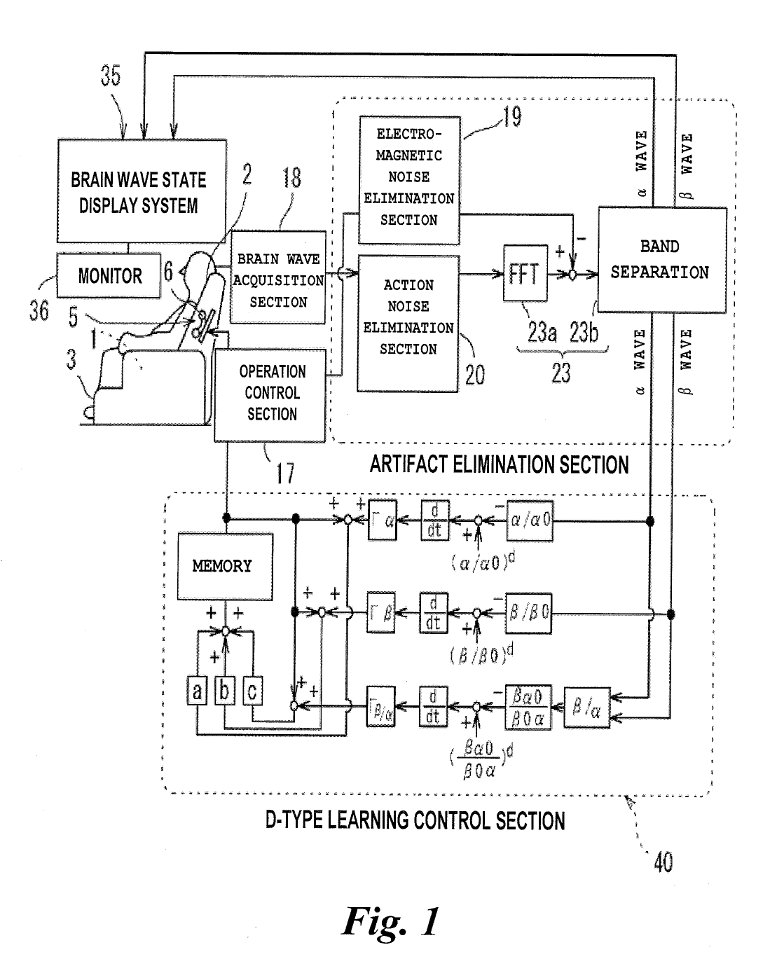

FIG. 1 is an explanatory view showing an embodiment of a massage machine according to the present invention. As a massage machine main body, this massage machine has a seat section 1 on which the user sits, a backrest section 2 provided backwardly of this seat section 1 and a footrest section 3 provided forwardly of the seat section 1, and the massage machine is a chair type. The user is massaged by this massage machine main body. The backrest section 2 can be turned (can be reclined) using a drive mechanism (not shown), and the footrest section 3 can be turned up and down around the front portion of the seat section 1 using another drive mechanism (not shown).

The massage machine main body has a massage unit 5, and this massage unit 5 is provided inside the backrest section 2. The massage unit 5 has a treatment operation section having treatment devices 6 for performing massage operations, such as rubbing, pounding and finger pressure, and a main body frame in which this treatment operation section is installed so as to be movable in the front-rear direction. The massage unit 5 is moved up and down along a pair of left and right guide rails provided inside the backrest section 2 using an up/down drive mechanism, not shown, provided for the massage machine main body. For example, the up/down drive mechanism may be a rack and pinion type, and has a structure in which the rack thereof is provided along the guide rails and the pinion thereof is provided in the massage unit 5 with a motor to rotate the pinion via a speed reducer.

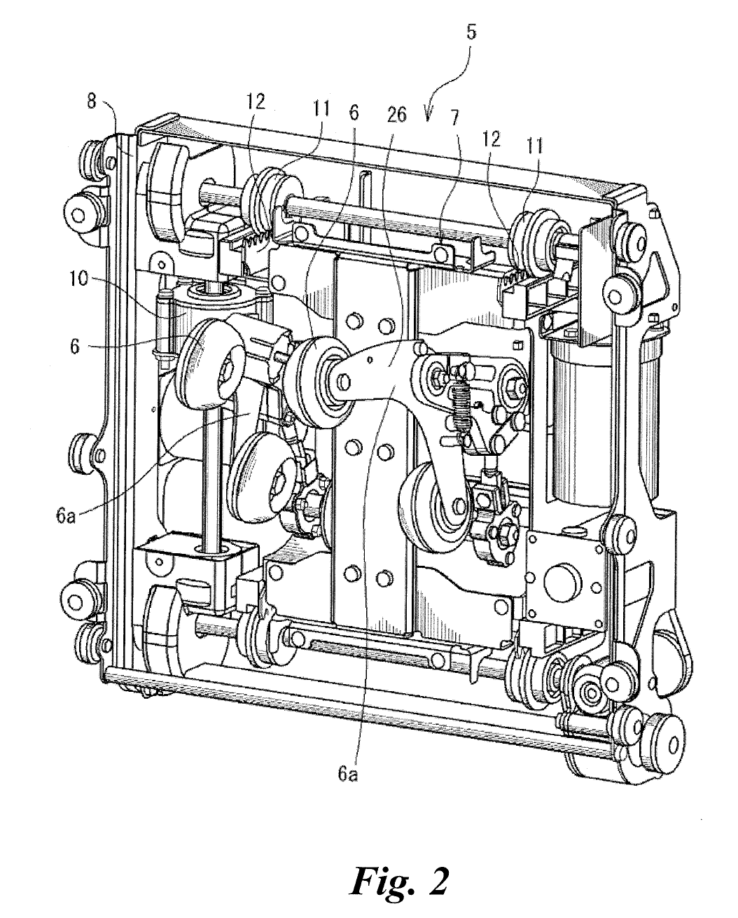

FIG. 2 is a front perspective view showing the massage unit 5. The massage unit 5 has pushing mechanisms for moving the treatment devices 6 in the front-rear direction of the backrest section 2. Each of the pushing mechanisms has a pushing motor 10 serving as a drive source for moving the treatment operation section 7 in the front-rear direction, a pinion 11 connected to this motor 10 via a speed reducing mechanism, and a rack 12 engaged with this pinion 11 and provided in the front-rear direction of the backrest section 2. The motor 10 and the pinion 11 are secured to the main body frame 8 of the massage unit 5, and the rack 12 is secured to the treatment operation section 7. Hence, when the pushing motor 10 is rotated in the forward-reverse direction, the pinion 11 is rotated in the forward-reverse direction, whereby the rack 12 is moved in the front-rear direction and the treatment operation section 7 is moved in the front-rear direction together with the rack 12.

Furthermore, the treatment operation section 7 has a rubbing mechanism and a pounding mechanism for driving the treatment devices 6 to perform massage operations, such as rubbing and pounding. Although not shown, the rubbing mechanism has a rubbing motor, a rubbing shaft and a power transmission section formed of gears, etc. for transmitting the power of the rubbing motor to the rubbing shaft. When the rubbing motor rotates, the rubbing shaft is rotated, whereby an arm 6a on which the treatment devices 6 are installed is rocked. As a result, the treatment devices 6 perform rubbing operation including components in the left-right direction. Moreover, the pounding mechanism has a pounding motor, a pounding shaft and a power transmission section formed of gears, etc. for transmitting the power of the pounding motor to the pounding shaft. When the pounding motor rotates, the pounding shaft is rotated, whereby the arm 6a is rotated eccentrically with respect to the axis line thereof in the left-right direction. As a result, the treatment devices 6 perform pounding operation including components in the front-rear direction.

Generally-used mechanisms may be adopted for the rubbing mechanism, the pounding mechanism and the pushing mechanisms, and the mechanisms other than those shown in the figure may be used.

By changing the moving amount of the treatment operation section 7 in the front-rear direction using the pushing mechanism, the massage output intensity of the treatment devices 6 mounted on the treatment operation section 7 can be changed. In other words, by moving the treatment operation section 7 significantly toward the user, the user leaning against the backrest section 2 receives a concentrated force (massaging force) from the treatment devices 6 by a reaction force due to his or her body weight. As a result, the user can feel a strong massaging force from the treatment devices 6. Conversely, when the treatment operation section 7 is moved rearward (toward a direction opposite to the user), the body weight of the user leaning against the backrest section 2 is supported by not only the treatment devices 6 but also the main body of the backrest section 2, whereby the massaging force received from the treatment devices 6 by the user becomes weaker than the above-mentioned concentrated massaging force. As a result, the user can feel a weak massaging force.

With the above-mentioned configuration, the massage unit 5 can perform massage operations, such as rubbing, using the treatment devices 6 for the user; furthermore, by adjusting the front-rear moving amount of the treatment devices 6 (the treatment operation section 7) through the pushing mechanisms, the massage output (intensity) thereof during massage operation can be changed. In addition, the massage operation and the massage output using the massage unit 5 are controlled through an operation control section 17 (see FIG. 1) provided in the massage machine.

Moreover, the massage machine has a brain wave acquisition section 18 for acquiring the brain wave of the user, and this brain wave acquisition section 18 acquires the brain wave of the user being massaged using the massage unit 5. The brain wave acquisition section 18 acquires the brain wave via a pair of electrodes attached to the head portion (forehead) and the ear (ear lobe) of the user. Then, the operation control section 17 controls the massage operation and the massage output of the massage unit 5 based on the brain wave acquired through the brain wave acquisition section 18.

Besides, the massage machine further has an artifact elimination section formed of an action noise elimination section 20 for eliminating action noise caused by the user's action (motion) from the brain wave acquired through the brain wave acquisition section 18, an electromagnetic noise elimination section (massage noise elimination section) 19 for eliminating electromagnetic noise caused by the massage unit 5 from the acquired brain wave, and an arithmetic section 23.

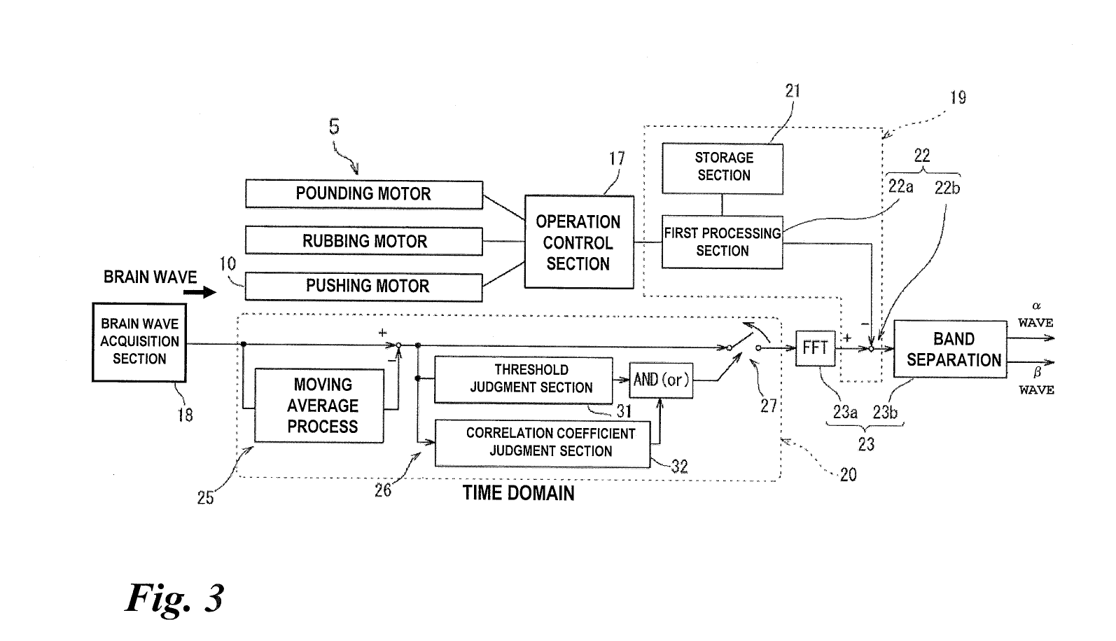

FIG. 3 is a block diagram showing the main part of the massage machine according to the present invention. The massage machine has a programmable microcomputer having a CPU and a storage section, and programs for executing given functions are stored in this storage section. The operation control section 17, the brain wave acquisition section 18, the electromagnetic noise elimination section 19, the action noise elimination section 20 and the arithmetic section 23 are configured as functions to be executed by these programs.

The operation control section 17 has functions for transmitting operation signals to the pushing mechanisms, the rubbing mechanism and the pounding mechanism (to the respective motors) and for causing the mechanisms to perform given operations. The function of the brain wave acquisition section 18 is to measure and acquire the user's brain wave, and a known function may be adopted.

[Action Noise Elimination Section 20 and Arithmetic Section 23]

The action noise elimination section 20 is configured so as to eliminate action noise caused by the user's action from the brain wave acquired through the brain wave acquisition section 18. Furthermore, it is configured that the function of the action noise elimination section 20 is performed before the electromagnetic noise elimination section 19 performs the process of eliminating electromagnetic noise.

The action noise elimination section 20 has a trend elimination section 25 for eliminating gentle fluctuation in a time domain in the brain wave acquired through the brain wave acquisition section 18. The trend elimination section 25 performs a moving average process on the original brain wave acquired through the brain wave acquisition section 18 and subtracts the brain wave subjected to the moving average process from the original brain wave acquired through the brain wave acquisition section 18. During the acquisition of the brain wave, when the user being massaged slowly moves his or her eyeball, the acquired brain wave gently fluctuates. However, the fluctuation in the brain wave can be eliminated through the function of the trend elimination section 25.

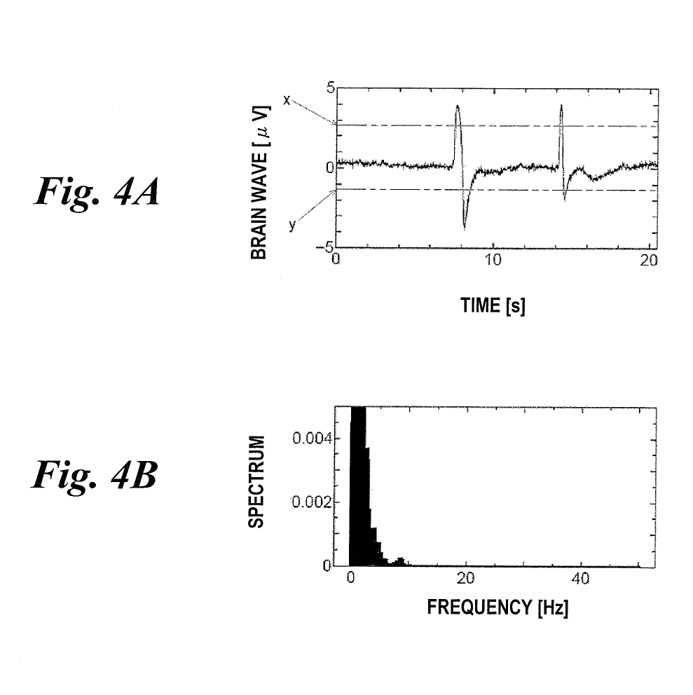

FIGS. 4A and 4B are views showing a brain wave including action noise caused by blinking, FIG. 4A showing the brain wave in a time domain, FIG. 4B showing the brain wave in a frequency domain. When the user blinks twice during the acquisition of the brain wave, two disturbances (two action noises) are included. It is known that, when a blink occurs, a positive output (μV) is generated in the brain wave and then a negative output (μV) is generated, as shown in this figure. As shown in FIG. 4B, action noise caused by blinking is included in the low frequency portion.

In FIG. 3, the action noise elimination section 20 has: a judgment section 26 for judging the presence of action noise caused by an user's quick eyeball action (blinking) in a processed brain wave (hereafter simply referring to as the processed brain wave) processed through the trend elimination section 25; and a selection section 27 for excluding a portion including the action noise from the processed brain wave. The judgment section 26 has a threshold judgment section 31 and a correlation coefficient judgment section 32.

The threshold judgment section 31 judges the presence of action noise caused by blinking by comparing the output value of the processed brain wave with preset threshold values. As shown in FIG. 4A, given threshold values x and y are set for the brain wave in the threshold judgment section 31. Furthermore, during the comparison between the output value of the processed brain wave and the threshold values x and y by the threshold judgement section 31, when the output value of the processed brain wave exceeds the threshold values, the judgment section judges that the corresponding brain wave portion as the time zone in which the user blinked. Since the output value of the brain wave increases abruptly when the user blinks as described above, the threshold judgment section 31 can judge the presence of the action noise caused by blinking.

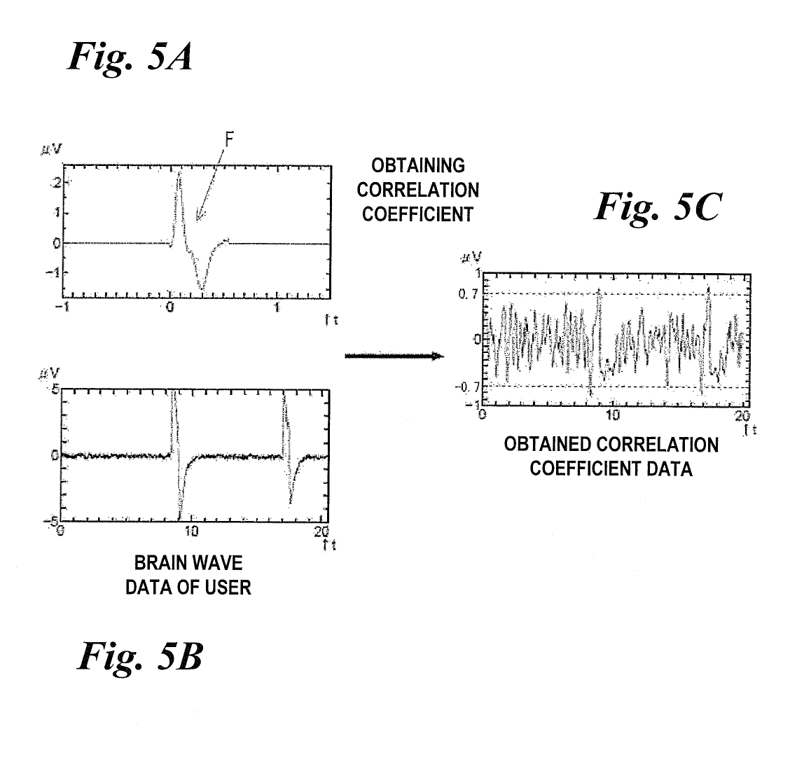

The correlation coefficient judgment section 32 judges the presence of the action noise by comparing the waveform of the processed brain wave with the model waveform of the action noise caused by an user's quick eyeball action (blinking). FIGS. 5A to 5C are explanatory views explaining the function of the correlation coefficient judgment section 32. The model waveform of the action noise caused by the user's blinking can be regarded as a waveform F shown in FIG. 5A. This model waveform F can be previously acquired through the brain wave acquisition section 18 upon the user's blinking, and the model waveform F is stored in the massage machine (the correlation coefficient judgment section 32).

Then, the correlation coefficient judgment section 32 obtains the correlation coefficient of the processed brain wave by using the model waveform F as a template, thereby detecting the blinking time zone from the processed brain wave. As generally known, the correlation coefficient is a statistical indicator indicating the similarity level between two probability variables and has a real value from −1 to +1. For example, if this value is close to +1, it indicates a positive high correlation therebetween, and if the value is close to −1, it indicates a negative high correlation. On the other hand, if the value is close to zero, it indicates a low correlation and that there is a low similarity.

Hence, according to the present invention, the correlation coefficient judgment section 32 obtains the similarity between the model waveform F and the waveform of the processed brain wave using this correlation coefficient and judges the presence of the action noise caused by blinking based on this result. As an actual process, the correlation coefficient judgment section 32 fixes the time series data of the processed brain wave shown in FIG. 5B and obtains the correlation coefficient between the two while advancing the model waveform F in time with respect to the data. FIG. 5C shows the waveform of the correlation coefficient obtained by this process. When FIG. 5C is compared with FIG. 5B, high correlation values are obtained around blinking actions in the processed brain wave. When the correlation value is judged as not less than a given threshold value or not more than another given threshold value (not less than +0.7 or not more than −0.7), the correlation coefficient judgement section 32 assumes that there is a high correlation and judges that the action noise caused by blinking is generated in the corresponding portion.

When the user blinks as described above, the brain wave has a specific waveform; hence, the correlation coefficient judgment section 32 can judge the presence of the action noise caused by blinking through the comparison between the waveform of the processed brain wave and the preset model waveform F. The time zone of the blinking can thus be detected.

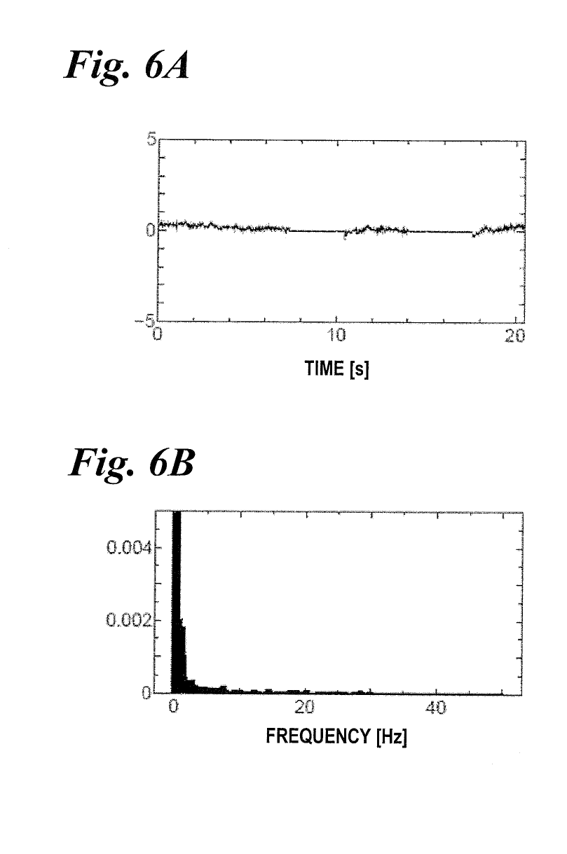

The selection section 27 shown in FIG. 3 excludes portions including the action noise caused by blinking from the processed brain wave (the brain wave as the massage operation control subject for the operation control section 17) depending on the judgment result of the judgment section 26, that is, depending on the judgment results of both or one of the threshold judgment section 31 and the correlation coefficient judgment section 32. Consequently, as shown in FIG. 6A, the portions of the blinking time zones can be eliminated from the processed brain wave. FIG. 6B is a view showing the brain wave of FIG. 6A in a frequency domain. When FIG. 6B is compared with FIG. 4B, noise components (low-frequency portions) are eliminated from the brain wave having been subjected to the process of eliminating action noise caused by blinking.

In FIG. 3, the first arithmetic section 23a of the arithmetic section 23 is an FFT arithmetic section and the arithmetic section converts the data obtained by eliminating the above-mentioned action noise from the processed brain wave into a frequency domain.

In addition, the second arithmetic section 23b of the arithmetic section 23 separates a given frequency band from the brain wave which is converted into the frequency domain through the first arithmetic section 23a and from which electromagnetic noise is removed through the electromagnetic noise elimination section 19 described later. The second arithmetic section 23b can acquire given frequency bands, that is, α and β waves, presenting in the brain wave.

As the summarization and explanation of the action noise eliminating method performed through the action noise elimination section 20, the method has the following steps.

1. Step of performing the moving average process on a brain wave including an eyeball action (blinking). 2. Step of eliminating the trend of the brain wave by subtracting a signal to which the moving average process is performed from the original brain wave. 3. Step of detecting the blinding time zones from the trend-eliminated brain wave while using the preset given threshold values. 4. Step of obtaining the correlation coefficient of the trend-eliminated brain wave by using a typical blinking waveform as a template and of detecting the blinking time zones, together with the Step 3. 5. Step of judging the time zone satisfying both or one of the Step 3 or Step 4 as a blinking time and of excluding the time zone from those to be subjected to the FFT process. 6. Step of extracting the α wave components and the β wave components from the FFT-processed brain wave in the no-blinking time zones.

Furthermore, even if the user performs a slow eyeball action other than blinking, action noise is also generated. However, since the brain wave is gently fluctuated by this action noise, the action noise can be eliminated through the trend elimination section 25.

With the above-configured massage machine according to the present invention, even if the user being massaged while his or her brain wave is measured performs a quick eyeball action such as blinking and a slow eyeball action, the noise generated by these eyeball actions can be eliminated from the acquired brain wave, and the components (α and β waves) of an accurate brain wave can be acquired.

In the judgment section 26, it is preferable to judge the time zones satisfying the judgement conditions of both the threshold judgment section 31 and the correlation coefficient judgment section 32 as the blinking-generated time zones. According to that, the threshold values x and y of the threshold judgment section 31 are set in narrow ranges, portions assumed to correspond to action noise caused by blinking are judged many times, and the correlation coefficient judgment section 32 selects action noise caused by true blinking from the judged portions based on the above-mentioned model waveform F.

[Electromagnetic Noise Elimination Section 19]

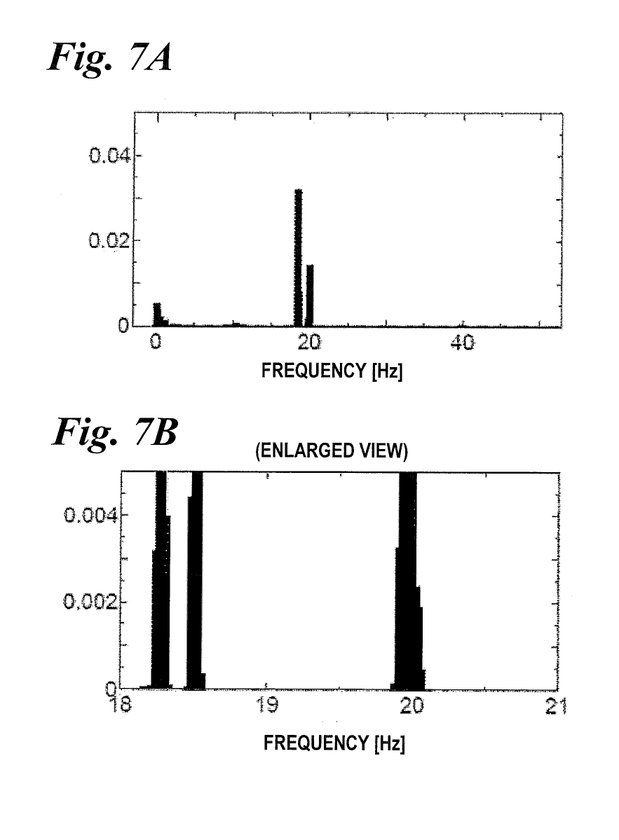

FIG. 7A is a view showing the frequency components of an acquired brain wave, and FIG. 7B is a magnified view showing 18 to 21 Hz zone. This brain wave is acquired from the user receiving a given pounding massage operation using the above-mentioned pounding mechanism provided in the massage unit 5. This brain wave includes not only α and β waves as the massage operation control subjects for the operation control section 17 but also noise at around 18 Hz and 20 Hz (more accurately, 18.2 to 18.81 Hz and 19.9 to 20.1 Hz). This noise is caused by the pounding mechanism of the massage unit 5. In other words, the above-mentioned pounding motor rotates when the pounding mechanism performs the given pounding massage operation. Hence, when the pounding operation is performed, electromagnetic noise having specific frequency components are included in the brain wave.

Consequently, in FIG. 3, the electromagnetic noise elimination section 19 performs a process of eliminating electromagnetic noise caused by the above-mentioned pounding mechanism performing the pounding massage operation from the brain wave from which the action noise is eliminated through the action noise elimination section 20, depending on the pounding massage operation during the acquisition of the brain wave.

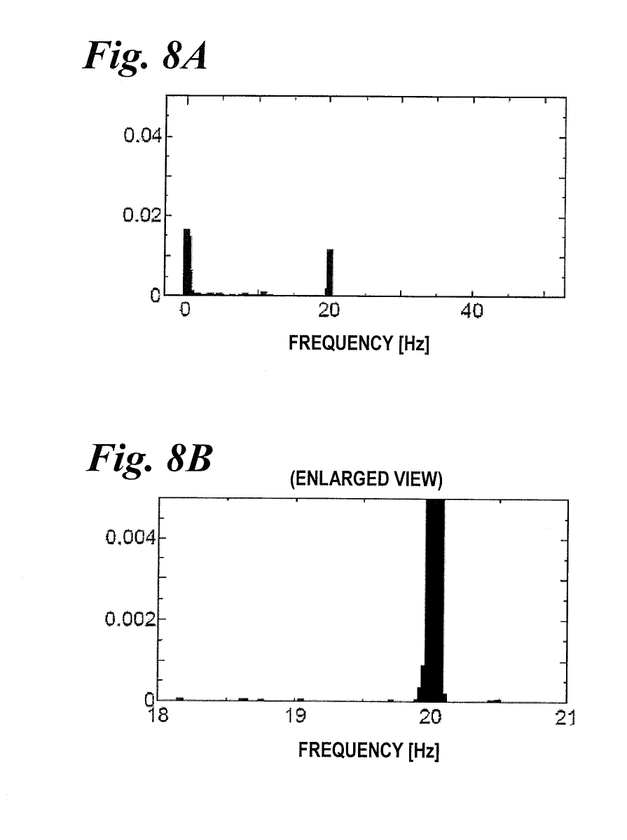

Furthermore, FIG. 8A is a view showing the frequency components of an acquired brain wave, and FIG. 8B is a magnified view showing 18 to 21 Hz zone. This brain wave is acquired from the user receiving a given rubbing massage operation using the above-mentioned rubbing mechanism provided in the massage unit 5. This brain wave includes not only α and β waves as the massage operation control subjects for the operation control section 17 but also noise at 20 Hz (more accurately, 19.9 to 20.1 Hz). This noise is caused by the rubbing mechanism of the massage unit 5. In other words, the above-mentioned rubbing motor rotates when the rubbing mechanism performs the given pounding massage operation. Hence, when the rubbing operation is performed, electromagnetic noise having specific frequency components are included in the brain wave.

Consequently, the electromagnetic noise elimination section 19 performs a process of eliminating electromagnetic noise caused by the rubbing mechanism of the massage unit 5 performing the rubbing massage operation from the brain wave from which the action noise has been eliminated, depending on the rubbing massage operation during the acquisition of the brain wave.

The configuration and process of the electromagnetic noise elimination section 19 will be described further. In FIG. 3, the electromagnetic noise elimination section 19 has a storage section 21 for storing related information described later and a processing section 22 for eliminating specific frequency components from the brain wave.

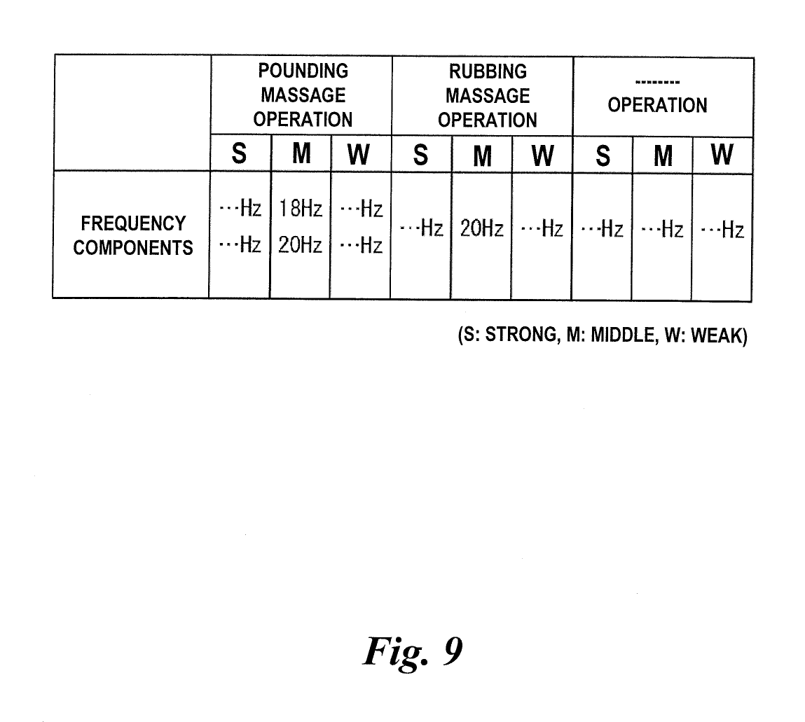

As shown in FIG. 9, the related information stored in the storage section 21 corresponds to the relationship between the type (massage operation mode) of massage operation performed using the massage unit 5 and the frequency components of specific electromagnetic noise caused by the massage unit 5 performing this type of massage operation.

More specifically, as the related information, when the type of massage operation is “pounding massage operation having a middle degree (middle) output”, the storage section 21 stores “18 Hz and 20 Hz” as the frequencies of specific electromagnetic noise. Similarly, as the related information, when the type of massage operation serving is “rubbing massage operation having a middle degree (middle) output”, the storage section 21 stores “20 Hz” as the frequency of specific electromagnetic noise. Instead of the table shown in FIG. 9, the related information may also be expressed using mathematical expressions.

In addition, in FIG. 3, from the operation control section 17, the first processing section 22a of the processing section 22 obtains operation information regarding the type of massage operation during the acquisition of the brain wave. Furthermore, based on this operation information, the first processing section 22a obtains the frequency components of specific electromagnetic noise corresponding to the massage operation during the acquisition of the brain wave. In other words, when “pounding massage operation (middle)” is performed as massage operation using the operation control section 17, the first processing section 22a obtains “18 Hz and 20 Hz” as the frequency components of the specific electromagnetic noise corresponding to this massage operation from the related information shown in FIG. 9.

Moreover, in FIG. 3, the second processing section 22b of the processing section 22 performs a process of eliminating the frequency components “18 Hz and 20 Hz” of the specific electromagnetic noise obtained through the first processing section 22a from the brain wave from which the above-mentioned action noise has been eliminated.

Hence, as described referring to FIG. 7A, since the brain wave includes electromagnetic noise at around 18 Hz and 20 Hz caused by the above-mentioned pounding mechanism, by performing the process of eliminating the frequency components “18 Hz and 20 Hz” of the specific electromagnetic noise through the electromagnetic noise elimination section 19, the electromagnetic noise caused by the pounding mechanism can be eliminated.

Further, similarly, when “rubbing massage operation (middle)” is performed as massage operation using the operation control section 17, the first processing section 22a obtains “20 Hz” as the frequency component of the specific electromagnetic noise corresponding to this massage operation from the related information shown in FIG. 9.

Still further, when the type of massage operation is “rubbing massage operation (middle),” as described referring to FIG. 8A, since the brain wave includes electromagnetic noise at around 20 Hz caused by the above-mentioned rubbing mechanism, by performing the process of eliminating the frequency component “20 Hz” of the specific electromagnetic noise through the electromagnetic noise elimination section 19, the electromagnetic noise caused by the pounding mechanism can be eliminated.

According to the above-described electromagnetic noise elimination section 19, the electromagnetic noise caused by the massage unit 5 can be eliminated from the brain wave based on the type of the massage operation of the massage unit 5 without affecting the required brain wave components (α and β waves) as much as possible. In addition, since the frequency components of specific electromagnetic noise corresponding to the massage operation during the acquisition of the brain wave can be obtained from the related information stored in the storage section 21, the process of eliminating the electromagnetic noise can be performed promptly.

A massage method to be performed by the above-configured massage machine is performed by acquiring the brain wave of the user being massaged by the massage machine using the brain wave acquisition section 18, by eliminating the electromagnetic noise caused by the massage machine through the electromagnetic noise elimination section 19 and by controlling the massage operation performed by the massage machine through the operation control section 17 based on the brain wave from which the electromagnetic noise has been eliminated.

In the massage machine and the massage method described above, when the massage unit 5 performs massage operation, although electromagnetic noise caused by the massage unit 5 may be included in the brain wave acquired through the brain wave acquisition section 18, since the electromagnetic noise elimination section 19 eliminates the electromagnetic noise caused by the massage unit 5 performing massage operation during the acquisition of the brain wave from the acquired brain wave, noise in the acquired brain wave is suppressed. The massage operation applied to the user can be performed at an appropriate output by controlling the massage operation through the operation control section 17.

[Brain Wave State Display System]

In FIG. 1, the massage machine according to the present invention has a brain wave state display system 35. This system 35 displays, for the user being massaged by the massage unit 5, the user's brain wave state as an indicator for judging the comfortableness degree during the massage. The system 35 has a monitor (displaying section) 36 viewed by the user sitting on the chair-type massage machine, and this monitor 36 is provided above the armrest sections, for example. The monitor 36 may also be provided in part of a controller to be operated by the user.

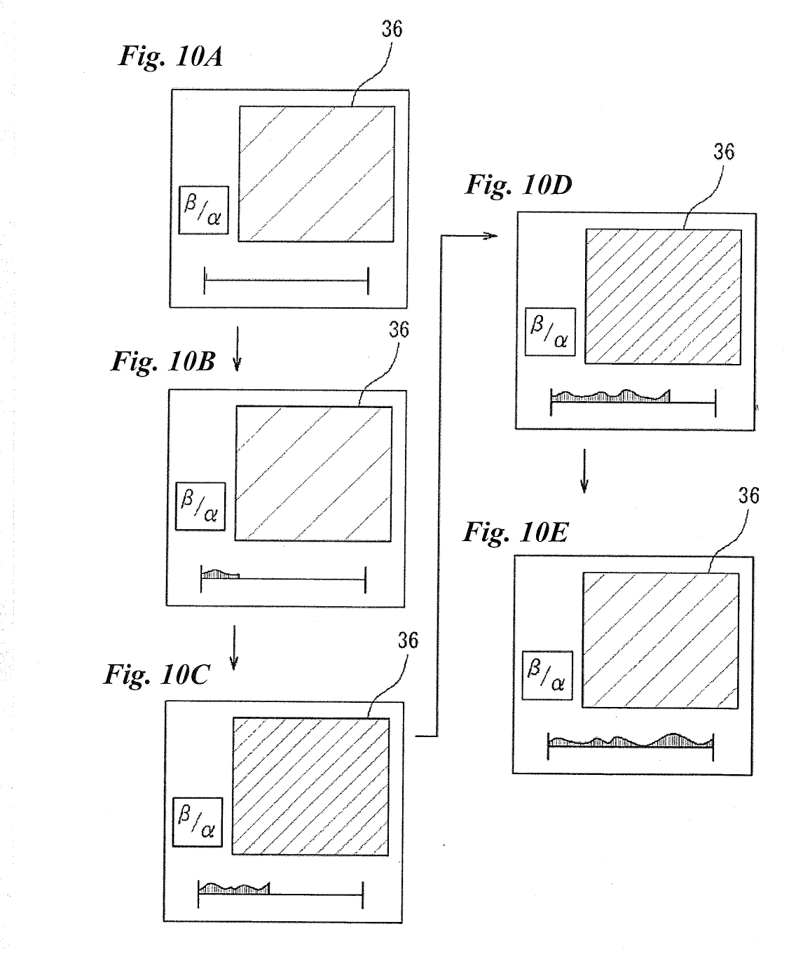

FIGS. 10A to 10E are explanatory views showing examples of brain wave states (display information) displayed on the monitor 36. The monitor 36 displays the user's brain wave states obtained based on the brain wave having been subjected to the processes of eliminating the action noise and the electromagnetic noise. The brain wave state display system 35 can obtain the values of the a and p waves acquired through the second arithmetic section 23b and performs a process of changing the display screen on the monitor 36 based on these values. While the user is being massaged, the display screen on the monitor 36 changes sequentially from FIG. 10A to FIG. 10E, with time.

The display colors of the monitor 36 are used as display information regarding the brain wave states displayed on the monitor 36, and the brain wave state display system 35 changes the colors of the monitor 36 based on the ratio (β/α) of the α wave value to the β wave value. In FIGS. 10A to 10E, the change in color is expressed as the change in the density of hatching. For example, as the ratio (β/α) becomes larger, the display color becomes close to red (dense hatching), indicating that the comfortableness degree is low. On the other hand, as the ratio (β/α) becomes smaller, the display color becomes close to blue (coarse hatching), indicating that the comfortableness degree is high.

Furthermore, as display information regarding the brain wave states displayed on the monitor 36, a bar graph in which the horizontal axis represents time and the vertical axis represents the ratio (β/α) is shown below the portion indicating the change in the display color. Hence, the change in the ratio (β/α) with respect to time can be graphed, and this change can be shown to the user. Furthermore, FIGS. 10A to 10E also shows the ratio (β/α) as the display information of the monitor 36.

Instead of the information regarding the ratio (β/α), information based on only the α wave or information based on only the β wave may also be displayed on the monitor 36. Moreover, the information regarding the α and β waves acquired when massage operation had been formerly (previously) performed may be stored in the massage machine, and the previous information may be compared with the current information when the same massage operation is performed.

As described above, when the user being massaged views the monitor 36, he or she can know his or her brain wave state in real time. Hence, it is possible to confirm the massage operation and the brain wave state, in other words, the fact that the indicator of the comfortableness degree has been enhanced. As a result, the user can visually comprehend the actual effect of massage, whereby an emotionally pleasant effect can be given.

In addition, since the values of the α and β waves to be input to the brain wave state display system 35 are obtained by eliminating the respective noise portions, the values become appropriate indicators representing the comfortableness degree (comfort/discomfort) of the user.

Furthermore, when the ratio (β/α) of the components of the brain wave to be displayed on the monitor 36 is significantly different from a preset general (standard) value, diagnostic information indicating that severe fatigue is anticipated can also be displayed on the monitor 36, for example.

Although a case in which the monitor 36 is installed on the massage machine is described in the above-mentioned embodiment, the monitor 36 may also be a monitor, not shown, provided for a computer disposed separate from the massage machine. In this case, a configuration should only be designed so that, while a program having the function of the brain wave state display system 35 is stored in, for example, a (home-use) computer, communication is established between the massage machine and the computer by connecting the massage machine to the computer via an interface cable, for example. With this configuration, the brain wave state can be displayed using the computer.

[D-Type Learning Control Section]

In FIG. 1, the massage machine according to the present invention has a D-type learning control section 40. This D-type learning control section 40 has functions for automatically setting the massage output based on the α and β waves of the user obtained from the brain wave having been subjected to the processes of eliminating the action noise and the electromagnetic noise, that is, depending on the comfortableness degree felt by the brain of the user being massaged and for performing control so that the massage output becomes more favorable for the user, as the number of usage times is increased.

The D-type learning control section 40 has an output setting section for setting the massage output. As shown in FIG. 1, this output setting section performs a process of obtaining the finger pressure of the next massage operation performed using the massage unit 5 by using the difference between the brain wave (the α and β waves and the ratio (β/α)) therebetween obtained through the brain wave acquisition section 18 when the treatment devices 6 performs massage operation at a given finger pressure (given massage output) and preset target values and also by using the given finger pressure applied when the massage operation was performed.

In FIG. 1, the target values are (α/α₀)^{d}, (β/β₀)^{d} and (β·α₀/β₀·α)^{d}, and α₀ and β₀ are the α wave and the β wave acquired when the user is in resting (not being massaged). In addition, Γα, Γβ and Γβ/α are learning gains. Furthermore, a, b and c in the blocks in FIG. 1 are coefficients satisfying the relationships of 0≦(a, b, c)≦1 and a+b+c=1 and weighted parameters for weighting the α wave component, the β wave component and the ratio (β/α) therebetween, respectively. Hence, the above-mentioned process is executed using at least one of the α wave, the β wave and the ratio (β/α) therebetween.

The D-type learning control section 40 performs control to adjust the massage output so that the brain wave obtained from the user becomes close to the target values thereof. Furthermore, by storing the massage output in the massage machine (the memory of the D-type learning control section 40), in the next massage, the massage output can be reflected.

The massage machine according to the present invention is not limited to the embodiment shown in the drawings but may include other embodiments within the scope of the present invention. For example, the configuration of the massage unit 5 may be other than that shown in the drawings and may have air cells that are expanded and contracted when air is supplied/exhausted by the operation of a compressor. Furthermore, the related information shown in FIG. 9 may also include information regarding other types of massage (massage operation using the air cells, rolling massage and vibratory massage) as the information regarding the type of massage (massage operation mode). Moreover, in addition to the intensity levels: strong, middle and weak, the information regarding the type of massage may also include information at each massaging speed.

In addition, in the above-mentioned embodiment, noise caused by the operation of the massage machine main body to be eliminated through the electromagnetic noise elimination section (massage noise elimination section) 19, is assumed as the noise caused by the operation of the mechanisms (the rubbing mechanism, the pounding mechanism, etc.) installed in the massage unit 5; however, in a rolling massage, noise is caused by the operation of a raising/lowering drive mechanism. The rolling massage is performed such that the massage unit 5 is raised/lowered using the raising/lowering drive mechanism while the treatment devices 6 are made contact with the user. In another case, as noise caused by the operation of the massage machine main body, noise may be caused by the operation of the drive mechanism for reclining the backrest section 2 and by operation of the drive mechanism for turning up and down the footrest section 3.

With the present invention, since noise is eliminated from the acquired brain wave, noise in the obtained brain wave can be suppressed. As a result, the massage output to be applied to the user can be made appropriate by controlling the operation of the massage machine main body based on the brain wave.

1. A massage machine comprising:
a massage machine main body that massages the user;
a brain wave acquisition section that acquires a brain wave of the user being massaged by the massage machine main body; and
an operation control section that controls an operation of the massage machine main body based on the brain wave acquired by the brain wave acquisition section, the massage machine further comprising:
a massage noise elimination section that eliminates a noise caused by the operation of the massage machine main body from the brain wave acquired through the brain wave acquisition section, based on the operation of the massage machine main body during an acquisition of the brain wave.

2. The massage machine of claim 1,
wherein the massage noise elimination section has:
a storage section that stores related information regarding the relationship between the operation of the massage machine main body and a noise component caused by the massage machine main body performing the operation; and
a processing section that obtains the noise component corresponding to the operation of the massage machine main body during the acquisition of the brain wave from the related information and that eliminates the thus-obtained noise component from the brain wave acquired through the brain wave acquisition section.

3. The massage machine of claim 1, further comprising:
an action noise elimination section that eliminates an action noise caused by an user's action from the brain wave acquired through the brain wave acquisition section.

4. The massage machine of claim 2, further comprising:
an action noise elimination section that eliminates an action noise caused by an user's action from the brain wave acquired through the brain wave acquisition section.

5. The massage machine of claim 3,
wherein the action noise elimination section has:
a judgment section that judges a presence of the action noise; and
a selection section that excludes a portion including the action noise from the brain wave as the operation control subject for the massage machine main body by the operation control section, based on a judgment result of the judgment section.

6. The massage machine of claim 4,
wherein the action noise elimination section has:
a judgment section that judges a presence of the action noise; and
a selection section that excludes a portion including the action noise from the brain wave as the operation control subject for the massage machine main body by the operation control section, based on a judgment result of the judgment section.

7. The massage machine of claim 5,
wherein the judgment section judges the presence of the action noise by comparing an output value of the brain wave acquired through the brain wave acquisition section with a preset threshold value.

8. The massage machine of claim 6,
wherein the judgment section judges the presence of the action noise by comparing an output value of the brain wave acquired through the brain wave acquisition section with a preset threshold value.

9. The massage machine of claim 5,
wherein the judgment section judges the presence of the action noise by comparing a waveform of the brain wave acquired through the brain wave acquisition section with a model waveform of the action noise caused by the user's action.

10. The massage machine of claim 3,
wherein the action noise elimination section further has:
a trend elimination section that performs a moving average process on the brain wave acquired through the brain wave acquisition section and that subtracts the brain wave subjected to the moving average process from the brain wave acquired through the brain wave acquisition section.

11. The massage machine of claim 9,
wherein the action noise elimination section further has:
a trend elimination section that performs a moving average process on the brain wave acquired through the brain wave acquisition section and that subtracts the brain wave subjected to the moving average process from the brain wave acquired through the brain wave acquisition section.

12. The massage machine of claim 1, further comprising:
a display section that displays, to the user, an user's brain wave state obtained based on the brain wave having been subjected to the noise elimination processes.

13. A massage method comprising:
acquiring a brain wave of the user being massaged by a massage machine;
eliminating a noise caused by the massage machine from the acquired brain wave; and
controlling a massage operation performed by the massage machine based on the brain wave from which the noise is eliminated.
